(19) United States
(12) Patent Application Publication
(10) Pub. No.: US 2016/0156480 A1
(43) Pub. Date: Jun. 2, 2016

(54) SWITCHING DEVICES

(71) Applicants: Inventec (Pudong) Technology Corporation, Shanghai City (CN); INVENTEC CORPORATION, Taipei City (TW)

(72) Inventor: Te-Yen LIU, Taipei City (TW)

(21) Appl. No.: 14/678,272

(22) Filed: Apr. 3, 2015

(30) Foreign Application Priority Data
Nov. 27, 2014 (CN) 201410709599.6

(51) Int. Cl. H04L 12/18; H04L 12/741

(52) U.S. Cl. CPC H04L 12/18; H04L 45/74

(57) ABSTRACT

A switching device comprises a physical-layer module, a routing module, a control-plane module, a data-plane module, and a storage module. The physical-layer module comprises a plurality of network interfaces and is coupled with the routing, control-plane, and data-plane modules. The control-plane module is adapted for maintaining a forwarding table upon receiving through the physical-layer module a configuration item from a control device. The data-plane module is adapted for processing, based on the forwarding table, a data packet received by the physical-layer module. The routing module is adapted for obtaining link states associated with the network interfaces. The routing or control-plane module is further adapted for sending the link states through the physical-layer module to the control device. The storage module, coupled with the control-plane and data-plane modules, is adapted for storing the forwarding table and optionally the link states.

### CROSS-REFERENCE TO RELATED APPLICATIONS

This non-provisional application claims priority under 35 U.S.C. §119(a) on Patent Application No(s). 201410709599.6 filed in China on Nov. 27, 2014, the entire contents of which are hereby incorporated by reference.

### BACKGROUND OF THE INVENTION

1. Technical Field of the Invention

The present invention relates to a network packet forwarding technology, particularly to a switching device applying the software-defined network (SDN).

2. Description of the Related Art

Taking the switch of the software-defined network (SDN) following the OpenFlow protocol for example, its control plane and data plane are separated, so that a controller can centralizedly manage routers. But sometimes the controller still relies on the topology discovery of the switch to exchange the link relations between the switches. Specifically, in the hop-by-hop mode of the OpenFlow, the switches usually publish their identities, ports, and abilities with each other with the Link Layer Discovery Protocol (LLDP) following the IEEE 802.1AB standards, so that the controller can query and organize these data according to the Simple Network Management Protocol. However, the LLDP packets are usually not forwarded, so when another non-OpenFlow switch following the LLDP exists between two OpenFlow switches, the two OpenFlow switches never know that they are connected in the SDN and the controller is unable to arrange the routing with their link relations.

### SUMMARY OF THE INVENTION

A switching device illustrated in an embodiment of the present invention includes a physical-layer module, a routing module, a control-plane module, a data-plane module, and a storage module. The physical-layer module includes a plurality of network interfaces. The routing module is coupled with the physical-layer module, for obtaining a plurality of link states in association with the plurality of network interfaces and sending the plurality of link states to a control device through the physical-layer module. The control-plane module is coupled with the physical-layer module, for receiving a configuration item from the control device through the physical-layer module and maintaining a forwarding table according to the configuration item. The data-plane module is coupled with the physical-layer module, for processing a data packet received by the physical-layer module according to the forwarding table. The storage module is coupled with the control-plane module and the data-plane module, for storing the forwarding table.

In an embodiment of the present invention, when sending the plurality of link states to the control device, the routing module sends a first multicast message through the physical-layer module, and the first multicast message records the plurality of link states.

In an embodiment of the present invention, the routing module sends the first multicast message periodically.

In an embodiment of the present invention, the routing module is further coupled with the storage module and the storage module is further for storing the plurality of link states.

In an embodiment of the present invention, the routing module is further for sending a second multicast message through the physical-layer module and the second multicast message records an identifier for identifying the switching device to the control device.

In an embodiment of the present invention, the routing module sends the second multicast message periodically.

A switching device illustrated in an embodiment of the present invention includes a physical-layer module, a routing module, a control-plane module, a data-plane module, and a storage module. The physical-layer module includes a plurality of network interfaces. The routing module is coupled with the physical-layer module, for obtaining a plurality of link states in association with the plurality of network interfaces. The control-plane module is coupled with the physical-layer module, for sending the plurality of link states to a control device through the physical-layer module and receiving a configuration item from the control device through the physical-layer module and maintaining a forwarding table according to the configuration item. The data-plane module is coupled with the physical-layer module, for processing a data packet received by the physical-layer module according to the forwarding table. The storage module is coupled with the control-plane module and the data-plane module, for storing the forwarding table.

In an embodiment of the present invention, the routing module is further coupled with the storage module and the storage module is further for storing the plurality of link states.

In an embodiment of the present invention, the routing module is further coupled with the control-plane module.

In an embodiment of the present invention, the configuration item is in association with one of the plurality of link states.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1 to FIG. 3 are block diagrams of the switching device according to different embodiments of the present invention;

FIG. 4 is a diagram of sending the IS-IS hello packet according to an embodiment of the present invention;

FIG. 5 is a structural diagram of the OpenFlow according to an embodiment of the present invention; and

FIG. 6A to FIG. 6C are diagrams of the routing table of the OpenFlow according to an embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

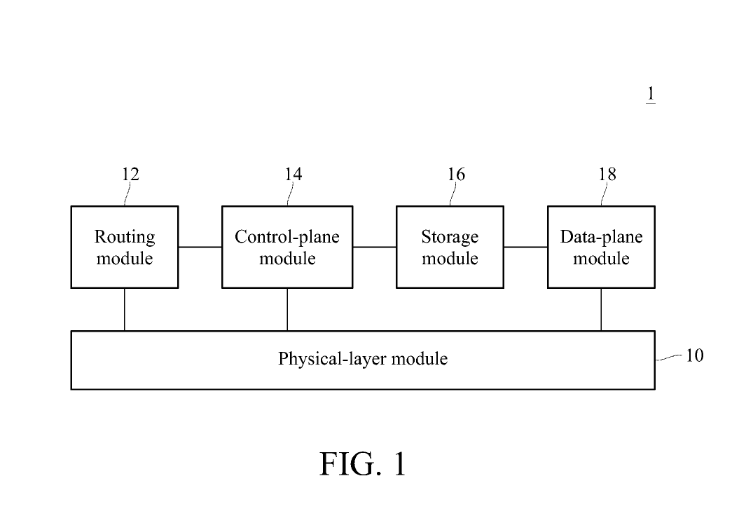

Please refer to FIG. 1. FIG. 1 is a block diagram of the switching device according to an embodiment of the present invention. As shown in FIG. 1, the switching device 1 includes a physical-layer module 10, a routing module 12, a control-plane module 14, a storage module 16, and a data-plane module 18. The physical-layer module 10 includes a plurality of network interfaces or ports. The specific design of the interface depends on one of a plurality of physical-layer protocols to which the switching device 1 corresponds. The routing module 12, the control-plane module 14, and the data-plane module 18 are part of the firmware of the switching device 1 or the logic circuit coupled with the physical-layer module 10 to send or receive packets through the physical-layer module 10. The part executed by the processing module of the switching device 1 is the corresponding module and the module is but not limited to a segment of codes or a physical hardware. For example, in the normal operation of the switching device 1, according to at least one forwarding table, the data-plane module 18 is for processing the packets which are sent to the switching device 1 and received or picked up by the physical-layer module 10. Therefore, the data plane is also called the forwarding plane. The data-plane module 18 possibly reroutes the received packets from a certain port to the switching device 1, or sends the packets to the routing module 12 or the control-plane module 14 for further processing, or abandons the packets directly.

The aforementioned processing module coupled with the physical-layer module 10 or the logic circuit is but not limited to a microprocessor, an application-specific integrated circuit, a field-programmable gate array, a complex programmable logic device, a system-on-chip, or a system-in-package.

The aforementioned forwarding table is stored in the storage module 16. The storage module 16 is coupled with the data-plane module 18 and the control-plane module 14. The storage module 16 is but not limited to a volatile/non-volatile memory, especially the content-addressable or associative memory.

As a member of the software-defined network (SDN), the switching device 1 has the characteristic of having the control-plane module 14 and the data-plane module 18. The software defined network is implemented with the OpenFlow protocol. The switching device 1 communicates with the control devices through the belonged control-plane module 14. In other words, the packets from the control device are received by the physical-layer module 10, and processed preliminarily, and delivered to the control-plane module 14 eventually. The control-plane module 14 is for working according to the packet, especially when the packet carries the instruction to the switching device 1 from the control device. For example, when the instruction is in association with a configuration item of the router, the control-plane module 14 maintains the forwarding table in the storage module 16 accordingly. The maintenance is adding the content of the configuration item to the forwarding table, deleting or modifying a certain item of the table, or adjusting the properties of the forwarding table, such as the field, the level, or the size. The storage module 16 or the aforementioned firmware possibly has the mechanism for preventing conflictions happened between the control-plane module 14 and the data-plane module 18.

The routing module 12 is for executing a routing protocol completely or incompletely. In an embodiment of the present invention, the routing protocol is based on the link state, such as the Intermediate System to Intermediate System (IS-IS). Therefore, the routing module 12 needs to obtain the link states in association with the network interfaces of the physical-layer module 10 by self-measuring or exchanging information with the nearby but not necessarily adjacent network device supporting the same routing protocol. The link state in association with a network interface is the cost of sending a packet to another terminal through the network interface. The cost is a mixed evaluation of communication latency, round-trip time, packet error, packet loss rate, or other measured value . . . etc. The interface and the link state are not necessary in one-to-one correspondence. For example, when the exchange module 1 has the ability of aggregating the links, it is possible that a plurality of interfaces correspond to one link state.

In an embodiment, the aforementioned routing protocol is packed in another protocol, so that the routing module 12 is able to cross the network devices which do not support the routing protocol through the measurement or exchanging packets sent by the physical-layer module 10. In other words, the packets are rerouted by the unsupported switches. The overlaid-layer protocol is referred to Transparent Interconnection of Lots of Links (TRILL). Taking the switching device 1 in the physical layer corresponding to the Ethernet for example, because the TRILL packet has a special EtherType and a multicast destination address, the switches unable to identify the packet usually forward the packet to other device through all of the interfaces except the packet source interface for expecting that a certain device with the destination address picks up the packet. On the contrary, because the network devices able to identify the LLDP EtherType are quite common and usually the default action of these network devices to the LLDP packet is usually to process the packet immediately and abandon it, using the routing module 12 to execute LLDP is not appropriate.

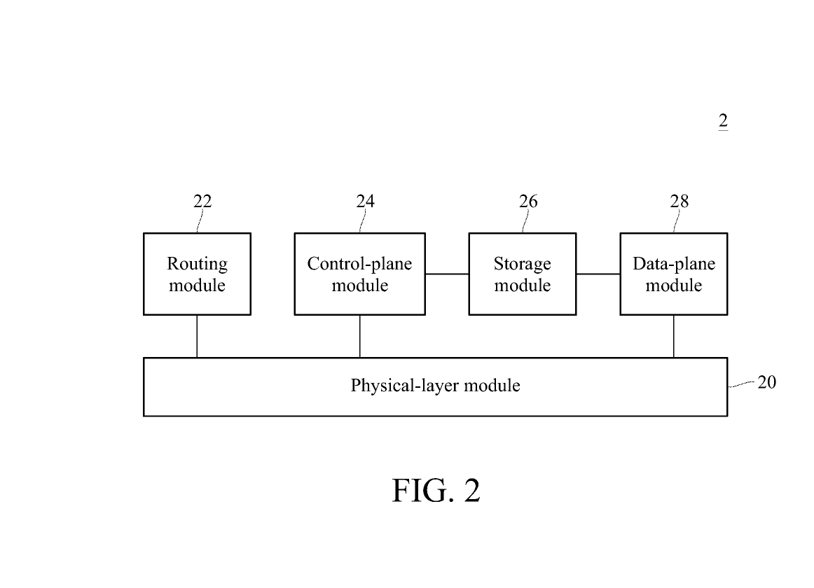

The routing module 12 is coupled with the control-plane module 14, so that the link state obtained by the routing module 12 can be sent to the control device by the control-plane module 14 through the physical-layer module 10. Like the other communications between the switching device 1 and the control devices, the control-plane module 14 usually sends the link state with unicast transmission. Please refer to FIG. 2. FIG. 2 is a block diagram of the switching device according to another embodiment of the present invention. As shown in FIG. 2, the switching device 2 includes a physical-layer module 20, a routing module 22, a control-plane module 24, a storage module 26, and a data-plane module 28. The physical-layer module 20 and 10 are similar and the physical-layer module 20 is coupled with the routing module 22, the control-plane module 24, and the data-plane module 28. In the aspect of maintaining, storing, and using the forwarding table, the control-plane module 24, the storage module 26, and the data-plane module 28 are similar to the module 14, 16, and 18 respectively. The storage module 26 is coupled with the data-plane module 28 and the control-plane module 24. Comparing to the routing module 12, except obtaining the link states of the network interfaces in association with the physical-layer module 20, the module 22 is further for sending the link states to the control device without the control-plane module 24. In an embodiment, the routing module 22 sends the link state to the control device with unicast transmission.

In another embodiment, sending the link state to control device from the routing module 22 represents that the routing module 22 completely executes the aforementioned routing protocol comparing to the module 12. For example, the routing module 22 implements the packet/protocol data unit (PDU) of the link state according to the IS-IS routing protocol. If the physical layer corresponding to the switching device 2 is an Ethernet, the link state packet is overlaid with the header of the second layer protocol of the Ethernet and the header records the destination addresses for the SDN members to pick up. The link state packet has a reachability field and the reachability field is filled with a list of nearby and compatible switching devices and the aforementioned metrics . . . etc. The routing module 22 can also expand the hello packet of the IS-IS, and the format of the hello packet is shown in Table 1, so that the nearby and compatible field in the list are further filled in the link states of the related switching devices, wherein the field is the IS Neighbor(s). Please be noted that the link state packet or the hello packet generated by the routing module 22 is adapted from the IS-IS, wherein the link state packet is the first multicast message and the hello packet is the second multicast message and the format of the link state packet is shown in Table 2. However, the multicast destination address and the EtherType of the link state packet or the hello packet are different from the IS-IS. When the routing protocol is packed with another protocol and the protocol is, for example, TRILL, the overlaid second layer header of the link state packet or the hello packet is still different from the general multicast destination address and the EtherType of TRILL or LLDP. In an embodiment, the switching device 2 identifies a certain network interface of itself with the name which is at least known by the control device in the SDN from the link state packet or the hello packet instead of the media access control address, wherein the name is, for example, the datapath identifier in the OpenFlow protocol.

TABLE 1

| Reserved/Circuit Type | |
|---|---|
| Source ID | |
| Holding Time | |
| PDU Length | |
| R | Priority |

LAN ID
Variable Length Fields

TABLE 2

| PDU Length | | | |
|---|---|---|---|
| Remaining Lifetime | | | |
| LSP ID | | | |
| Sequence Number | | | |
| Checksum | | | |
| R | ATT | OL | IS Type |

Varible Length Fields

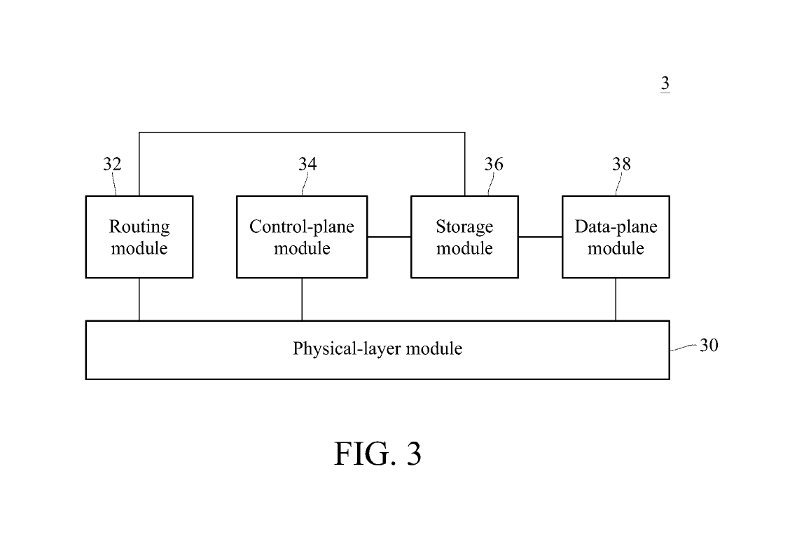

Please refer to FIG. 3. FIG. 3 is a block diagram of the switching device according to a further embodiment of the present invention. As shown in FIG. 3, the switching device 3 includes a physical-layer module 30, a routing module 32, a control-plane module 34, a storage module 36, and a data-plane module 38. The physical-layer module 30 is similar to the physical-layer module 10 and is coupled with the routing module 32, the control-plane module 34, and the data-plane module 38. With respect to the maintenance, the storage, and the utilization of the forwarding table, the control-plane module 34, the storage module 36, and the data-plane module 38 are similar to the module 14, 16, and 18 respectively. The storage module 36 is coupled with the data-plane module 38 and the control-plane module 34.

The routing module 32 is coupled with the storage module 36 and is for recording the link states obtained by measuring or exchanging into the storage module 36. Comparing to the embodiment in FIG. 1, the control-plane module 34 obtains these link states from the storage module 36 and sends the link states to the control device through the physical-layer module 30. The routing module 32 and the control-plane module 34 are not working simultaneously here. Comparing to the embodiment in FIG. 2, the routing module 32 executes the aforementioned routing protocol more completely than the module 22 does, so that the routing module 32 needs an intermediate storage. Taking IS-IS for example, the routing module 32 exchanges the hello packet with the nearby and compatible network devices through the physical-layer module 30 in advance, and then the storage module 36 builds a adjacency list based on the routing protocol, wherein the hello packet is the second multicast message. According to the list, the routing module 32 exchanges the link state packet with the nearby devices through the physical-layer module 30 for the storage module 36 to build a link state database, wherein the link state packet is the first multicast message. The routing module 32 sends link state in association with the network interfaces of the physical-layer module 30 to the control device with the first multicast message. Otherwise, the control-plane module 34 sends the link state to the control device with unicast transmission.

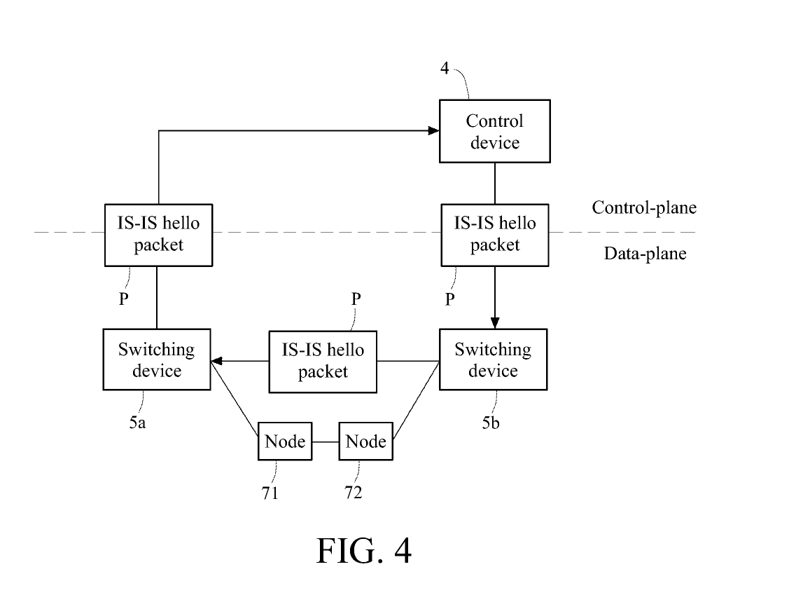

For example, please refer to FIG. 4. FIG. 4 is a diagram of sending the IS-IS hello packet according to an embodiment of the present invention. As shown in FIG. 4, the compatible network devices 4, 5a, 5b are available to exchange the IS-IS hello packet P to each other and create the adjacency list of the routing protocol accordingly.

In an embodiment, the first multicast message is sent once. In another embodiment, the first multicast message is sent periodically. In a further embodiment, taking the switching device 3 for example, the first multicast message is sent when the routing module 32 is triggered. For example, the routing module 32 receives the link state packet from another device through the physical-layer module 30 or receives the instruction of the control device rerouted by the control-plane module 34.

In an embodiment, the second multicast message is sent periodically and is also taken as the keep-alive packet in the SDN.

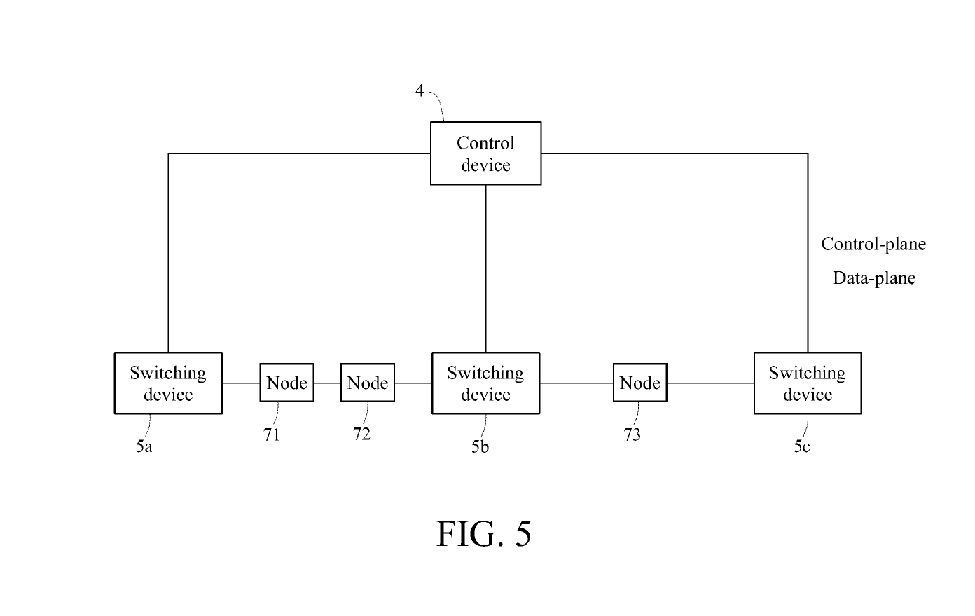

Please refer to FIG. 5. FIG. 5 is a structural diagram of the OpenFlow according to an embodiment of the present invention. As shown in FIG. 5, the control device 4 arranges the routers 71˜73 on the Internet according to the link states sent by a plurality of switching devices 5a˜5c of the present invention in the SDN. For a single switching device, a certain router passing the switching device represents that the control device takes at least one link state of the switching device into account when the control device is calculating the router and the control device sends related configuration items to the switching device. The control device solves the shortest path problem to arrange the path for unicast transmission, such as using Dijkstra's algorithm. When calculating the path for multicast transmission, the control device further prunes the distribution tree according to the virtual local area network (VLAN) to which each switching device belongs and the adjacent terminal devices.

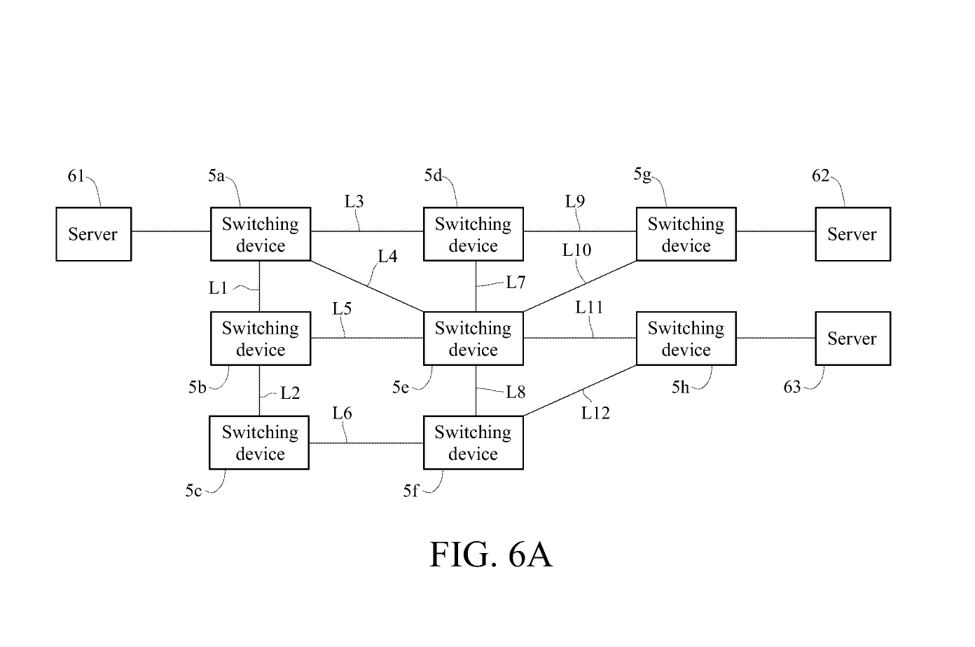

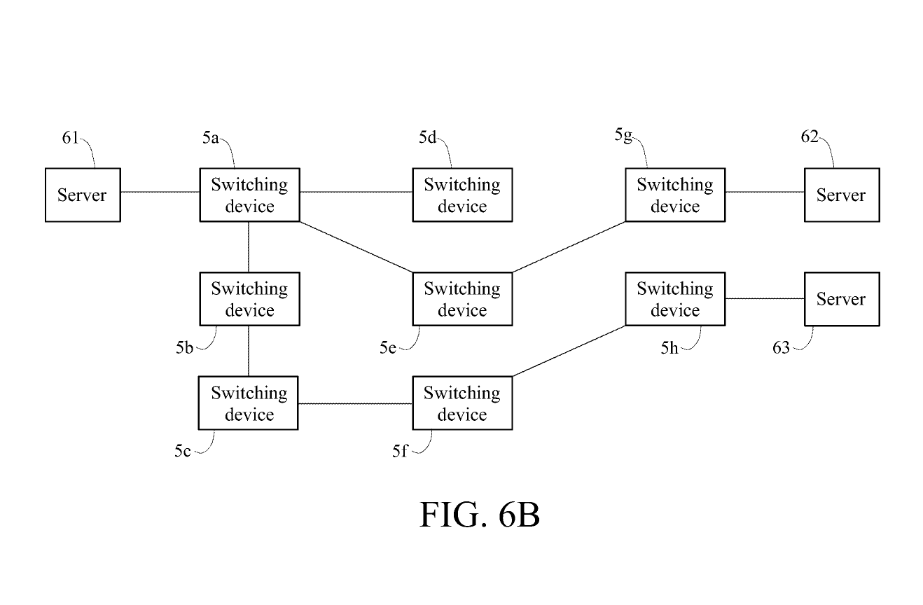

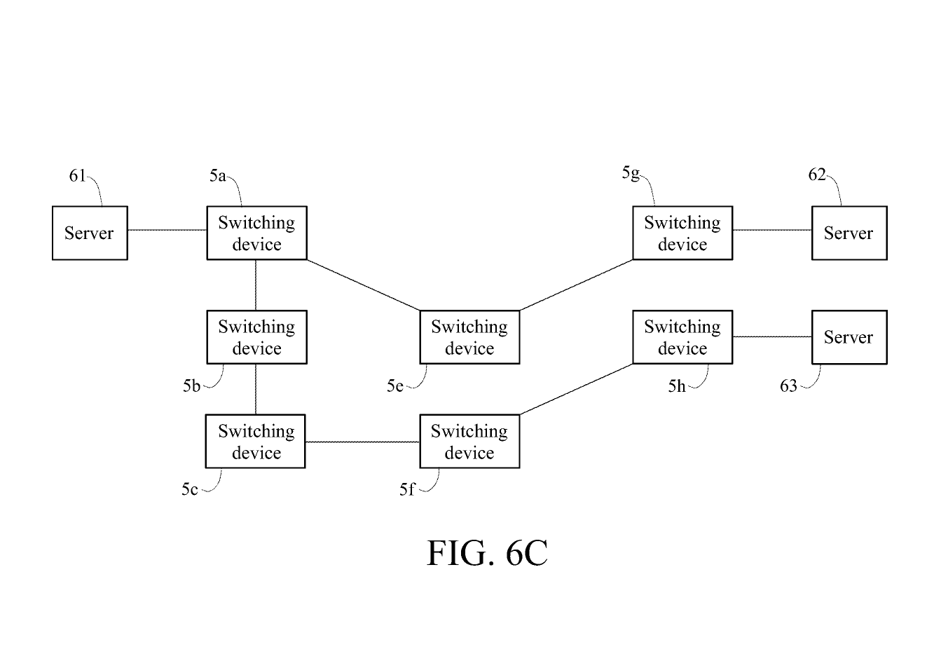

For example, please refer to FIG. 6A to FIG. 6C. FIG. 6A to FIG. 6C are diagrams of the routing table of the OpenFlow according to an embodiment of the present invention. As shown in FIG. 6A, the server 61 wants to send packets to the server 62 and 63 through the switching devices 5a˜5h, wherein there are the paths L1˜L12 between the switching devices. Assuming that the routing costs of the paths L1˜L12 are shown in Table 3 as follows:

TABLE 3

| | | | | | |
|---|---|---|---|---|---|
| L1 | 2 | L2 | 1 | L3 | 4 |
| L4 | 4 | L5 | 10 | L6 | 2 |
| L7 | 3 | L8 | 2 | L9 | 5 |
| L10 | 1 | L11 | 8 | L12 | 4 |

When the server 61 wants to send packets to the server 62 through the switching devices 5a˜5h, the best path for the switching devices obtained by applying the Dijkstra's algorithm is shown in FIG. 6B. When the server 61 wants to send packets to the server 62, the best path is through the switching devices 5a, 5e, and 5g and the switching devices 5a, 5e, and 5g are set to the configuration item.

In addition, when the server 61 wants to send packets to the server 62 and 63 through the switching devices 5a˜5h, the switching devices in the path are further pruned according to FIG. 6B obtained by Dijkstra's algorithm. In the figure, because the switching device 5d is not connected with any server, pruning the switching device 5d in the path is available and FIG. 6C is obtained accordingly. The switching device 5a, 5b, 5c, 5e, 5f, 5g, and 5h are set to the configuration item.

Referring to the process of finding the shortest path for sending packets to the server 62 and 63 using Dijkstra's algorithm by the server 61, specifically, it is a process of finding a shortest path between different points. For example, the algorithm for searching a shortest path between the server 61 and the server 62 is searching a shortest path between the switching device 5a to the switching device 5g, and the procedure therein is described as below: first, the routing costs between switching device 5a and the switching devices 5b˜5g are set to infinite. Next, the process starts from the switching device 5a and probes other directly reachable switching devices, such as 5b, 5e, and 5d corresponding to the path L1, L4, L3 respectively. In addition, according to Table 3, the routing costs of the path L1, L4, and L3 are 2, 4, and 4, and the starting point is 5a. The aforementioned information is recorded accordingly.

Next, the process starts from the selected switching device 5b corresponding to the smallest routing cost, that is, 2 and probes other directly reachable switching devices except 5a, such as 5c and 5e corresponding to the path L2 and L5 respectively. According to Table 3, the routing costs corresponding to L2 and L5 are 1 and 10 respectively. However, because the routing cost between the switching device 5a and 5c is infinite in the previous step, the path between 5a and 5c through 5b is L1+L2 and the corresponding routing cost is 3, which is less than infinite. Therefore, the routing cost between 5a and 5c is recorded as 3 and the intermediate point is 5b. In addition, the path between the switching device 5a and 5e is determined by selecting the shortest path from the direct path L4 whose routing cost is 4 and the indirect path L1+L5 through the switching device 5b whose routing cost is 12. Therefore, the shortest path between the switching device 5a and 5e is still L4.

Next, the process starts from the switching device 5c corresponding to the second smallest routing cost, that is, 3 in the previous step and probes other directly reachable switching device, such as 5b and 5f corresponding to the path L2 and L6 respectively. According to Table 3, the routing costs corresponding to L2 and L6 are 1 and 2 respectively. However, the routing cost between the switching device 5a and 5b is determined as 2 in the previous step. In addition, the path between 5a and 5f through 5c is L1+L2+L6 and the corresponding routing cost is 5, which is less than infinite. Therefore, that the routing cost of the path between 5a and 5f is 5 is recorded and the intermediate point is 5c.

Next, the process starts from the switching device 5d corresponding to the third smallest routing cost, which is 4 and probes other directly reachable switching device except 5a, such as 5e and 5g corresponding to the path L7 and L9 respectively. According to Table 3, the routing costs corresponding to L7 and L9 are 3 and 5 respectively. However, the direct routing cost between the switching device 5a and 5e is determined as 4 in the previous step and is less than the routing cost 4 of the indirect path between 5a and 5e through 5d, in other words, L3+L7. Therefore, the shortest path between 5a and 5e is unchanged. In addition, the path between 5a to 5g through 5d is L3+L9 and the corresponding routing cost is 9, which is less than infinite. Therefore, that the routing cost of the path between 5a and 5g is 9 is recorded and the intermediate point is 5d.

Next, the process starts from the switching device 5e corresponding to the fourth smallest routing cost, that is, 4 and probes other directly reachable switching device except 5a, such as 5b, 5d, 5f, 5g, and 5h corresponding to the path L5, L7, L8, L10, and L11 respectively. According to Table 3, the routing costs corresponding to L5, L7, L8, L10, and L11 are 10, 3, 2, 1, and 8 respectively. However, the smallest routing cost between the switching device 5a and 5b is determined as 2 in the previous step and is less than the routing cost 14 of the indirect path between 5a and 5b through 5e, in other words, L4+L5. Therefore, the shortest path between 5a and 5b is unchanged. The smallest routing cost between the switching device 5a and 5d is 4 and is less than the routing cost 7 of the indirect path between 5a and 5d through 5e, in other words, L4+L7. Therefore, the shortest path between 5a and 5d is unchanged. The smallest routing cost between the switching device 5a and 5f is 5 and is less than the routing cost 6 of the indirect path between 5a and 5f through 5e, in other words, L4+L8. Therefore, the shortest path between 5a and 5f is unchanged. The smallest routing cost between the switching device 5a and 5g is 9 and is greater than the routing cost 5 of the indirect path between 5a and 5g through 5e, in other words, L4+L10. Therefore, the smallest routing cost between 5a and 5g is replaced by 5 and the intermediate point is 5e. Consequently, the server 61 is able to reach the server 62 through the shortest path 5a, 5e, and 5g according to the aforementioned calculations. Likewise, the shortest path between the server 61 and the server 63 is calculated.

What is claimed is:

1. A switching device, comprising:
a physical-layer module comprising a plurality of network interfaces;
a routing module coupled with the physical-layer module, for obtaining a plurality of link states in association with the plurality of network interfaces and sending the plurality of link states to a control device through the physical-layer module;
a control-plane module coupled with the physical-layer module, for receiving a configuration item from the control device through the physical-layer module and maintaining a forwarding table according to the configuration item;
a data-plane module coupled with the physical-layer module, for processing a data packet received by the physical-layer module according to the forwarding table; and
a storage module coupled with the control-plane module and the data-plane module, for storing the forwarding table.

2. The device of claim 1, wherein when sending the plurality of link states to the control device, the routing module sends a first multicast message through the physical-layer module, and the first multicast message records the plurality of link states.

3. The device of claim 2, wherein the routing module sends the first multicast message periodically.

4. The device of claim 2, wherein the routing module is coupled with the storage module and the storage module is for storing the plurality of link states.

5. The device of claim 1, wherein the routing module is for sending a second multicast message through the physical-layer module and the second multicast message records an identifier for identifying the switching device to the control device.

6. The device of claim 5, wherein the routing module sends the second multicast message periodically.

7. The device of claim 1, wherein the configuration item is in association with one of the plurality of link states.

8. A switching device, comprising:
a physical-layer module comprising a plurality of network interfaces;
a routing module coupled with the physical-layer module, for obtaining a plurality of link states in association with the plurality of network interfaces;
a control-plane module coupled with the physical-layer module, for sending the plurality of link states to a control device through the physical-layer module and receiving a configuration item from the control device through the physical-layer module and maintaining a forwarding table according to the configuration item;
a data-plane module coupled with the physical-layer module, for processing a data packet received by the physical-layer module according to the forwarding table; and
a storage module coupled with the control-plane module and the data-plane module, for storing the forwarding table.

9. The switching device of claim 8, wherein the routing module is coupled with the storage module and the storage module is for storing the plurality of link states.

10. The switching device of claim 8, wherein the routing module is coupled with the control-plane module.

11. The switching device of claim 8, wherein the configuration item is in association with one of the plurality of link states.
